(19) United States
(12) Patent Application Publication
(10) Pub. No.: US 2014/0143299 A1
(43) Pub. Date: May 22, 2014

(54) SYSTEMS AND METHODS FOR MEDICAL IMAGING VIEWING

(71) Applicant: GENERAL ELECTRIC COMPANY, Schenectady, NY (US)

(72) Inventor: Jason Dieter Klotzer, Woodside, NY (US)

(73) Assignee: General Electric Company, Schenectady, NY (US)

(21) Appl. No.: 13/683,377

(22) Filed: Nov. 21, 2012

(51) Int. Cl. H04L 29/06

(52) U.S. Cl. CPC H04L 67/42
USPC 709/203

(57) ABSTRACT

Certain examples provide systems and methods for zero footprint medical image viewing through remote functionality execution. An example method includes monitoring execution at a client device. The example method includes establish a communication channel with a client device and exchanging messages via the channel. The example method includes routing execution from the client device to a server and facilitating execution of the functionality at the server. The example method includes routing a result of the execution back to the client device. The example method includes facilitating output of the results for access via the client device.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Prior to the rapid onset of digital imaging, patient images were “printed” to film. The film was “hung” and viewed by radiologists, who would then dictate a report. Reports were transcribed by individuals ranging for administrative staff to medical transcriptionists and sent to ordering physician via mail or fax. Critical results were delivered by phone or pager and business statistics were managed via paper reports and spreadsheets.

As information systems for radiology came to market, the first commercially available solutions addressed the needs of the radiologist and the radiology department. These included Radiology Information Systems (RIS) and dictation transcription systems. RIS systems managed the ordering, scheduling, patient and management reporting processes while radiologists were still reading from film.

As modalities started to support the digital display of images on workstations connected to the acquisition device, Picture Archiving and Communications Systems (PACS) came to market. These centrally store images and provide radiologists with the tools to read studies on networked computer monitors, replacing both film and modality workstations.

Over time, the needs of the market have evolved from supporting specialized radiologist workflows to supporting the open and dynamic needs of the enterprise and the community. The vendor community has added systems to manage the need for advanced technologies for better diagnosis; the sharing of images between providers and organizations; to support collaboration between radiologists, physicians and teams providing care for the patient; to close the loop on reporting of critical results and manage the growing storage requirements. Often these are disparate, best-of breed systems that may or may not interoperate, increasing cost and decreasing productivity.

### BRIEF SUMMARY

Certain examples provide systems and methods for zero footprint medical image viewing through remote functionality execution.

Certain examples provide a method including monitoring execution at a client device. The example method includes establish a communication channel with a client device and exchanging messages via the channel. The example method includes routing execution from the client device to a server and facilitating execution of the functionality at the server. The example method includes routing a result of the execution back to the client device. The example method includes facilitating output of the results for access via the client device.

Certain examples provide a tangible computer-readable storage medium including computer program code to be executed by a processor, the computer program code, when executed, to implement a method. The example method includes monitoring execution at a client device. The example method includes establish a communication channel with a client device and exchanging messages via the channel. The example method includes routing execution from the client device to a server and facilitating execution of the functionality at the server. The example method includes routing a result of the execution back to the client device. The example method includes facilitating output of the results for access via the client device.

### BRIEF DESCRIPTION OF SEVERAL VIEWS OF THE DRAWINGS

FIG. 1 illustrates a flow diagram of an example method to implement programmable workstation functions at a client via a viewer.

FIG. 2 illustrates a flow diagram of an example method for image streaming between a browser on a client device and an image viewer system.

FIG. 3 illustrates a flow diagram for an example method to facilitate remote function execution on a client device.

FIG. 4 illustrates an example zero footprint viewer.

FIG. 5 is a block diagram of an example processor system that may be used to implement systems and methods described herein.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EMBODIMENTS

### I. Overview

In certain examples, a unified viewer workspace for radiologists and clinicians brings together capabilities with innovative differentiators that drive optimal performance through connected, intelligent workflows. The unified viewer workspace enables radiologist performance and efficiency, improved communication between the radiologist and other clinicians, and image sharing between and across organizations, reducing cost and improving care.

The unified imaging viewer displays medical images, including mammograms and other x-ray, computed tomography (CT), magnetic resonance (MR), ultrasound, and/or other images, and non-image data from various sources in a common workspace. Additionally, the viewer can be used to create, update annotations, process and create imaging models, communicate, within a system and/or across computer networks at distributed locations.

In certain examples, the unified viewer implements smart hanging protocols, intelligent fetching of patient data from within and outside a picture archiving and communication system (PACS) and/or other vendor neutral archive (VNA). In certain examples, the unified viewer supports image exchange functions and implements high performing streaming, as well as an ability to read across disparate PACS without importing data. The unified viewer serves as a “multi-ology” viewer, for example.

In certain examples, a native reading worklist is provided via the unified viewer. The worklist is intuitive and user defined and can include multi-identifier, multi-document, and multi-institution, for example.

Certain examples provide workflow integration via the unified viewer. Workflow integration includes integration with reporting systems, worklists, voice recognition (VR), electronic medical records (EMR); exporting of measurements; exporting of exam notes; thin slice management; etc.

### II. Programmable Workstation Functions

In certain examples, programmable client workstation functions can be implemented using a WebSockets transport layer. In many cases, when complex functionality or resource intensive applications need to be deployed on a workstation, the applications are deployed as executables (EXE), libraries (DLL) or other deployment form that is able to execute directly as part of the hardware and not be “interpreted” (e.g., JavaScript) before the code is executed. The application code can also be invoked through a component object model (COM)-based method invocation if the code is to be consumed by a website (e.g., ActiveX). However, these implementations involve many security requirements to run in a web browser and/or interact with the operating system on the client device (e.g., in Microsoft Windows 8 and Internet Explorer 10, plugins are to be banned from a browser unless running specifically in “desktop” mode). Additionally, many components (e.g., ActiveX components) also require signing to be allowed to run on a client.

In certain examples, a viewer (e.g., a zero footprint (ZFP) viewer, etc.) uses WebSockets, which are fully supported by modern web browsers, to allow the web browser to interact directly with the client device. The direct interaction is accomplished by triggering the client device to run a service or installable component on the client device. The installable component or service is put in a “listen” mode on a predefined communication port of the client device. When a web application on the client is launched, the listening component/service polls for an open connection on a predefined WebSocket port.

Upon making a connection on the ZFP system, the client application can access functions defined with a WebSocket server that is deployed on the ZFP system (e.g., the WebSocket connection manager 251). For example, the client application can achieve all functionality that can equivalently be wrapped in an ActiveX component, but without the constraints of running the code directly in the browser or requiring additional security authorization for that session. In certain examples, these functions are defined in an interface that is shared between the client and server. The client interface is a loose contract with a pseudo-service layer implemented through WebSockets on the server, for example.

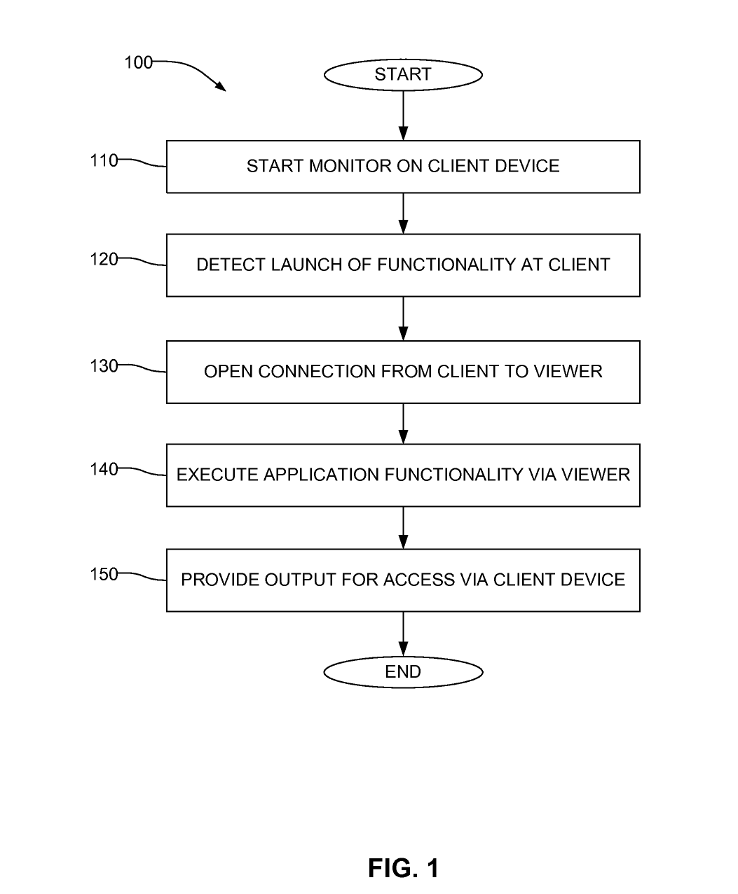

FIG. 1 illustrates a flow diagram of an example method 100 to implement programmable workstation functions at a client via a viewer. At block 110, a monitoring application is executed on a client device. The monitoring application “listens” to activity (e.g., function calls, communications, application execution, etc.) occurring on the client device (e.g., triggered by a web browser, image viewer, etc.). The monitoring application executes in the background so as not to interfere with or appreciably slow down normal operation of the client device. The monitoring application can be configured or assigned to listen on a predefined communication port of the client device, for example.

At block 120, an invocation or launch of functionality for execution at a client browser is recognized by the monitoring application. For example, an operating system-level call for information, such as a number of monitors associated with a system, a graphics card present in the system, and/or other information that is not typically accessible from web browser level code, can be detected upon invocation at the client device.

At block 130, upon detecting a launch at the client device, the monitoring device opens a connection to the viewer system (e.g., a zero footprint viewer working in conjunction with a middle-tier server to provide functionality to the client device). For example, the monitoring device polls for an open connection on a predefined WebSocket (or Web Services) port on the viewer. Upon making a connection, an application on the client can access functions defined and deployed on the viewer server.

At block 140, application functionality is executed on the server. That is, requested application functionality is executed on the server for the client rather than directly on the client. The client application can access server functionality without being limited by client constraints (e.g., resource limitations, client browser execution constraints, security concerns, etc.).

At block 150, an output of the application execution is provided for access via the client device. For example, output of execution at the server is provided to a client browser such that the client device receives the benefit of the execution without a user being aware that the execution did not occur on the client device (but instead occurred at the viewer, for example).

### III. Image Streaming

Certain examples enable streaming of medical images, such as DICOM images, directly to a web browser on a client device, without a need for extra or specialized components (e.g., a ZFP browser or viewer). Using WebSockets associated with HTML5 in a browser provides full bi-directional and binary communication without polling or asynchronous JavaScript (Ajax) calls with a Web or other content server. WebSockets (and/or TCP-based sockets) allow a communication channel to be established through which the client and server send messages back and forth to one another at any given time, as long as the communication channel stays active (e.g., the browser page does not change). DICOM medical images can be sent to a user browser without the need for Translation (e.g., no base64 encoding or decoding, etc.).

A WebSockets-based DICOM image streaming protocol within the ZFP viewer facilitates image selection from within a study based on a DICOM service-object (SOP) pair instance unique identifier (UID). The selected image can be a specific frame selected from within a multi-frame image. A specific compression and/or transcoding factor can be provided for a selected image, as can a scaling factor of the original image.

Using the image streaming protocol of the ZFP viewer, subsections of the original DICOM image can be requested. For example, meta information (e.g., from a DICOM image header) can be obtained. Image overlay information, image lookup table (LUT) information, image palette information, etc., can also be obtained and used to stream images via the ZFP viewer.

Further, via the ZFP viewer image streaming protocol, an order of original requested information can be changed. Further, non-image objects (NIOs), such as key objects, structured reports, GSPS, etc., can be requested.

A combination of the above features creates a ZFP solution for streaming DICOM images directly to a web browser using HTML5 WebSockets.

An example image streaming protocol includes receiving a request for image data from a web browser (e.g., a request to open a study). In certain examples, an image streaming engine allows transcoding of image data on the server (e.g., JPEG2000 to JPEG, JPEG to RAW, RAW to JPEG, etc) as well as requesting rescaled or region-of-interests of the original image data. This allows the client to request images specifically catered to a situation (e.g., low bandwidth, high bandwidth, progressive display, etc). In an example, a default is provided for the client to request a 60% quality lossy compressed JPEG of the original image, and then to request the raw data afterwards. This allows the image to be displayed very quickly to the client and while retrieving the lossless (raw) data in the pipe for diagnostic quality image display in follow-up.

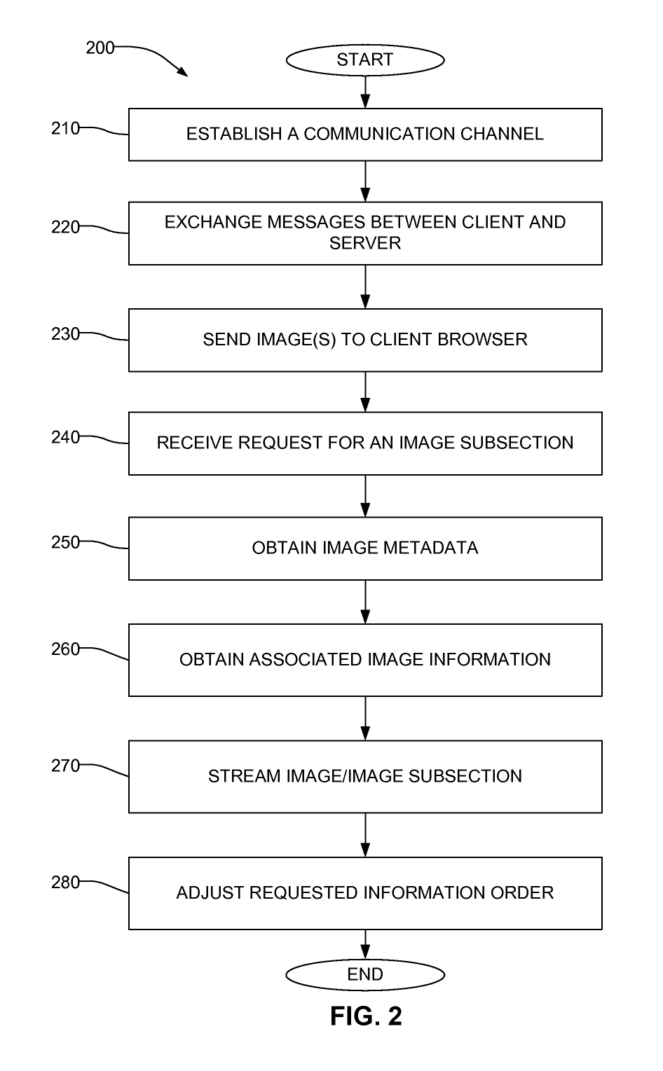

FIG. 2 illustrates a flow diagram of an example method 200 for image streaming between a browser on a client device and an image viewer system. At block 210, a communication channel is established between the client device and a viewer server (e.g., a zero footprint viewer and/or associated middle-tier server). The communication channel can be established using WebSockets, Web services, TCP/IP, etc. At block 220, messages are exchanged between client and server.

At block 230, medical images (e.g., DICOM medical diagnostic images) are sent to the client browser from the server without translation. At block 240, a request for an image subsection is received. For example, a user can select an area of interest in the displayed image via a selection tool in the client browser. The select triggers a request for further detail in that image subsection.

At block 250, meta information regarding the image is obtained. For example, a DICOM header for the image can be read to extract meta information for the image and/or its selected subpart. At block 260, associated image information (e.g., image overlay, lookup table, palette, etc.) is obtained (e.g., from the middle tier (e.g., ZFP) server to the web browser client, etc.). At block 270, metadata and associated image information are used to stream image(s) and/or image subsection(s) via the server (e.g., ZFP viewer) to the client browser.

At block 280, an order of requested information is adjusted. For example, a user and/or program can change an order of image streaming, request non-image objects, etc.

### VIII. Remoting Function Translations

Certain examples provide translation of JavaScript remoting function over WebSockets. “Remoting” or remote method invocation is defined within .NET, Java, and other languages, for example. Certain examples define and translate remoting functionality (e.g., implemented in JavaScript) to allow methods executed on a client device to call simple JavaScript code client and then be routed to a ZFP server via an encapsulated WebSocket connection for more involved processing and/or execution. A result or return value is then routed back to the client via the WebSocket connection.

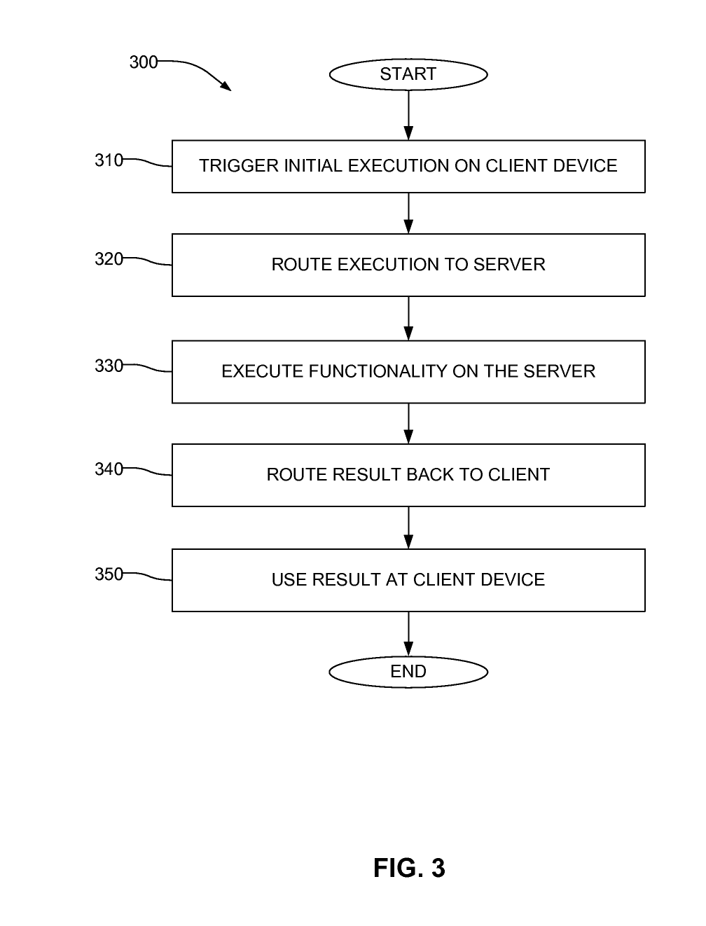

FIG. 3 illustrates a flow diagram for an example method 300 to facilitate remote function execution on a client device. At block 310, a request triggers initial execution of a script or other code on a client device. At block 320, execution is routed to a server or other ZFP system. For example, a basic script begins processing on the client device but then initiates a connection to the server for more involved execution of a desired process.

For example, a function call that is executed using a “proxy” class on the client is sent over to the server, and the result is sent back to the client. An example of this is to determine if the current user is logged in to the system. A call on the client side is, for example, “proxy.IsClientLoggedIn( )” and is routed through the proxy class to the server, where business logic checks if the user is in fact logged in. A Boolean result is then sent back to the client.

In certain examples, routing to the server is done by serializing method invocation using JSON (JavaScript Object Notation) and passing the serialized block of data to the server through a WebSocket connection.

At block 330, the initiated functionality executes on the server, rather than the client. For example, the server can de-serialize the received block of data and, in a zero footprint example, find an appropriate mapped attribute for the method invocation (e.g., in its .NET code). The server then executes the identified/mapped code.

At block 340, a result is routed back to the client. For example, a return value from the called code is serialized back to JSON and returned to the client via the WebSocket connection, completing the round trip. At block 350, the result is used at the client device. For example, display and/or manipulation of image data is reflected in a browser at the client device.

### XI. Zero Footprint Medical Image Viewer

Certain examples provide systems, methods, and apparatus for a zero foot print (ZFP) viewer and/or ZFP viewing by which programmable functions, remoting, and/or image streaming can be facilitated. The ZFP viewer can display medical images, such as Digital Imaging and Communications in Medicine (DICOM) images, for example. In certain examples, the ZFP viewer can be implemented using Hyper Text Markup Language 5 (HTML5).

In certain examples, having zero footprint can be defined as no administrator rights or special configuration changes required to install and use the application (e.g., radiologist viewer and/or clinician viewer, etc.), providing the application to run on multiple browsers (e.g., Internet Explorer™, Firefox™, Safari™, Chrome™, etc.) and on multiple operating systems (Microsoft™ Windows, Apple OS, iOS™, Android™, etc.), providing portability to work on mobile platforms and a variety of device display sizes, require minimal or reduced computing resources (e.g., processor, memory, etc.) at the client, have acceptable performance on low bandwidth connections, etc.

The ZFP viewer can facilitate image viewing and exchange. For example, DICOM images can be viewed from a patient's longitudinal patient record in a clinical data repository, vendor neutral archive, etc. A DICOM viewer can be provided across multiple PACS databases with display of current/priors in the same framework, auto-fetching, etc.

In certain examples, the ZFP viewer is implemented based on a client framework that is able to work with multiple backend architectures. For example, a common interface, icons, annotations, terminology, tools, behaviors, etc., can be provided. An open application programming interface (API) can facilitate multiple bi-directional integrations with external systems such as reporting, EMR, VR, LDAP, etc.

Zero footprint and zero or silent deployment can be facilitated by server-side rendering of images. For example, image processing of advanced applications can occur on the server, rather than the client.

Additionally, events can be synchronization across embedded application. Logs can be generated for learning, indexing, auditing of the user activities, etc.

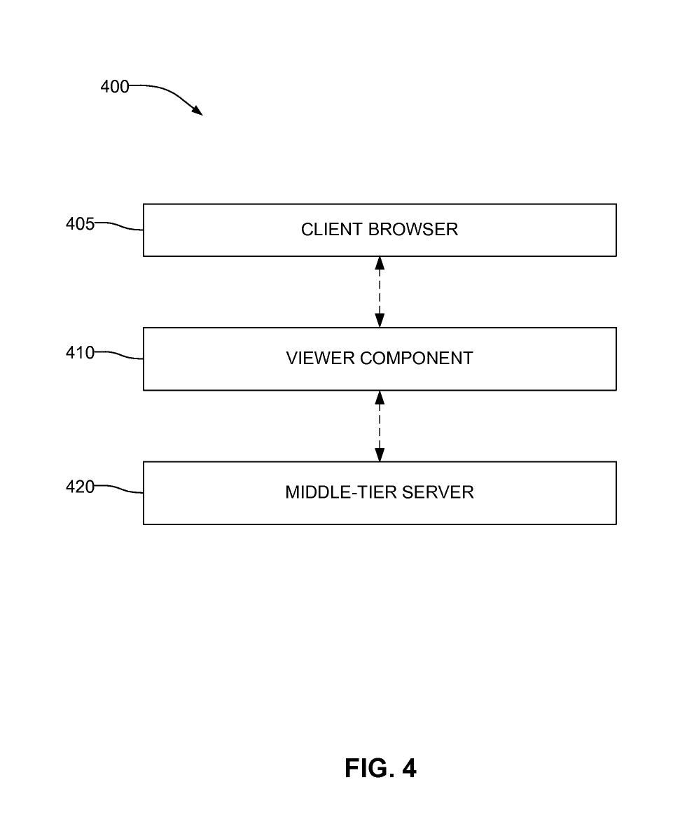

FIG. 4 illustrates an example ZFP viewer 400. The example ZFP viewer 400 is a DICOM medical image viewer that does not require any client installation or downloads of any component, and can run on virtually any hardware that is able to support an HTML5 browser (e.g., all modern hardware and operating systems). The flexibility and lack of client footprint provided by the ZFP viewer 400 is accomplished by providing several components in the viewer 400. The example ZFP viewer system 400 of FIG. 4 includes a viewer component 410 and a middle-tier server 420 providing image content and facilitating display and manipulation of the content at a client browser 405.

The viewer component 410 is the rendering/manipulation component of the ZFP viewer 400 (e.g., a rendering and manipulation engine for the ZFP HTML5 browser). In certain examples, the viewer component 410 uses HTML5 canvas element(s) to facilitate dynamic, scriptable rendering of shapes, images, and/or other graphical elements. In certain examples, the viewer component 410 is also able to render using Web Graphics Library (WebGL). Thus, the viewer engine 410 can provide a variety of dynamic two-dimensional (2D) and/or three-dimensional (3D) renderings for viewing (and interaction) by a user via the ZFP viewer 400.

The middle-tier server 420 drives conversion of image data to a format for viewing (e.g., a browser-friendly or browser-convenient format). The middle-tier server 420 supports transcoding of image data, such as DICOM data, for display via the viewer component 410. For example, the middle-tier serve 320 facilitates transcoding of image pixels, such as transcoding between DICOM-centric compression format(s) (e.g., Joint Photographic Experts Group committee 2000 (JPEG2000) image compression and coding format, etc.) and format(s) more suitable for modern browsers (e.g., Portable Network Graphics (PNG) image format). For non-image object and meta information, the middle-tier server 420 converts binary-based formats to browser-convenient formats, such as JavaScript Object Notation (JSON), etc.

In certain examples, transcoding is a direct digital-to-digital data conversion of one encoding to another. By facilitating transcoding at the middle-tier server 420, the viewer component 410 and the ZFP viewer 400 as a whole does not have to require a client device (e.g., a phone, tablet computer, laptop computer, desktop computer, etc.) to support a particular file format. Through transcoding, the middle-tier server 420 facilitates operation on a client device having a limited storage capacity and/or by occupying limited space for viewing on the client device regardless of how much space is actually available on the client. Transcoding by the middle-tier server 420 can facilitate conversion of old, incompatible, and/or obsolete data formats to a format suitable for viewing via the viewer component 410. Transcoding can be performed during search and/or presentation of image and/or non-image files, for example. Transcoding can be a lossy or a lossless process, for example. For example, transcoding can be lossless if the input is losslessly compressed and the output is either losslessly compressed or uncompressed. The process of lossy-to-lossy transcoding introduces varying degrees of generation loss.

In certain examples, the middle-tier server 420 performs a two-phase transcoding. First, a data file is decoded into an intermediate, uncompressed format. Second, the intermediate, uncompressed format is encoded into a target format.

In certain examples, data can be re-encoded in the same format for editing, lower bitrate, image scaling, etc. For example, for image editing of a JPEG image, the image file is decoded, edited, and re-encoded via the viewing component 410 and the middle-tier server 420.

In certain examples, files can be transrated to a lower bitrate. Transrating is a process similar to transcoding in which files are coded to a lower bitrate without changing formats. Transrating can include sample rate conversion, for example, but may use a same sampling rate with higher compression. By transrating, media can fit in a smaller storage space, over a lower bandwidth channel, etc.

The middle-tier server 420 can also facilitate image scaling for the viewing component 410. Changing image size is known as transsizing and can be used, for example, if an output resolution differs from a resolution of the media. Imaging scaling can be facilitated by the middle-tier server 420 on playback, via re-encoding, as part of transrating, etc.

Thus, the middle-tier server 420 can employ transcoding to help ensure proper display of content on a diverse variety of devices. The middle-tier server 420 provides an intermediate state of content adaptation to help ensure that source content can be displayed on a target device. In certain examples, the middle-tier server 420 provides real-time (or near real-time) transcoding in a many-to-many format (e.g., “any” input format to “any” output format) to provide search of, display of, and interaction with image and/or other content on a variety of devices via the ZFP viewer 400.

In certain examples, the ZFP viewer facilitates WebSockets-based DICOM image streaming. For example, an image's original format can be maintained through retrieval and display via the ZFP viewer. Certain examples provide programmable workstation functions using a WebSockets transport layer. Certain examples provide JavaScript remoting function translation over WebSockets.

In certain examples, the ZFP viewer facilitates WebSockets-based DICOM image streaming. For example, an image's original format can be maintained through retrieval and display via the ZFP viewer. Certain examples provide programmable workstation functions using a WebSockets transport layer. Certain examples provide JavaScript remoting function translation over WebSockets.

Certain examples provide memory-sensitive image browsing via the ZFP viewer. For example, an amount of resources used can be tracked, and data can be paged off of the server.

Certain examples provide form factor-based streaming technology via the ZFP viewer. For example, based on an available size of a client device, a resolution compressed image is sent to the client viewer for first display while the full lossless image is downloaded in the background.

Certain examples provide scalable vector graphics (SVG) based DICOM grayscale softcopy presentation states (GSPS) for the Web via a ZFP viewer.

Certain examples provide a multi-level image cache middle tier. For example, a middle tier can be provided for data storage so as to avoid storing a large amount of information on the client side.

Certain examples provide an “intelligent” Web browser client capability workflow.

Thus, the system 300 provides a single unified viewer that integrates with multiple types of existing back end systems and provides direct online access to images residing on any of the multiple types of existing back end systems, for example.

In certain examples, a format of an original image (e.g., an original DICOM image) is maintained through retrieval and display via a ZFP viewer. One or more image sub-sections can be requested and used over a communication channel, such as a Transmission Control Protocol (TCP) connection. Using a protocol, such as a WebSocket protocol, direct binary data retrieval can be enabled without encoding. WebSockets provides full-duplex communications over a single TCP connection, for example. Using WebSockets, messages can be passed back and forth between a client browser (e.g., running the viewer component 410 of the example of FIG. 4) and a server (e.g., the middle-tier server 420 of FIG. 4) with an open connection enabling an ongoing bi-directional conversation or exchange of messages conveying information between the server and the browser. Messages can be exchanged as a series of data packets, for example.

In certain examples, an abstract header (e.g., a packet header) is created for each data packet. The header describes and/or otherwise identifies the packet. Using the packet header in conjunction with a block of data, data can be sent as the client wants or expects. For example, DICOM image data can be streamed directly to the browser in the data's native form (e.g., binary).

Rather than encoding and/or otherwise encapsulating the data (e.g., base 64 encoding) at the server, sending the encoded data to the client, and decoding the data at the client via a plugin or applet, WebSocket functionality at the client browser can be used to identify received unencoded data at the protocol level without extra add-on or large increase in overhead. Rather than using a thick client application, encapsulating data as a Web service, or encapsulating data as an application service provider (ASP) call, data can be provided directly to a thin client browser, for example.

Certain examples provide a ZFP medical imaging viewer capable of providing full presentation states (e.g., grayscale softcopy presentation states). A presentation state is an independent DICOM service-object pair (SOP) Instance that includes information regarding how a particular image is to be displayed. For example, a presentation state can include label information (e.g., label type, position, etc.), windowing value, zoom value, scrolling (panning) value, rotation, and/or other visual display element defined within the DICOM standard. A presentation state can be applied to an image so that the image is displayed with the visual specifications defined by the presentation state. Using a presentation state, an image can be displayed in a certain way but is not modified, thereby allowing a program or other user to revert back to the original image, if desired. Presentation states can be sent to a picture archiving and communication system (PACS) and retrieved separate from and/or in conjunction with an image when requested.

For example, a grayscale softcopy presentation state (GSPS) allows a DICOM application entity to specify how stored pixel data values in a composite image object are to be translated to presentation values (P-values) that are independent of device or manufacturer. A display device converts the P-values to luminance for a softcopy display, for example. A grayscale standard display function defines a linearly perceived response and can be used to calibrate display devices such that images appear similar in grayscale contrast when displayed according to transformations specified in the GSPS. As with other presentation states, GSPS allows image display characteristics to be separated from stored image objects and updated independently. In certain examples, the GSPS includes extensions to allow for rotation, zooming, panning, annotation, etc., with vector graphics and plain text. Images can be selected individually and/or as part of a set of images from one or more studies to which the GSPS is to be applied.

Using full presentation states, a DICOM image can run fully on the ZFP viewer without running plugins or special display software on the client device. DICOM information is preserved for an image so that the DICOM information can be directly manipulated on the client (e.g., window level, zoom, pan, etc.).

Certain examples provide a ZFP client viewer that runs on a web browser in HTML5 and is client device independent. The ZFP viewer includes a data manager that allows a user to keep a certain amount of data on the client (e.g., in a middle tier image cache), while paging data back and forth with a server via the data manager. Such “intelligent” paging helps to facilitate memory sensitive image browsing on ZFP Web-based browser. For example, a user can scroll between different images in a study and be unaware that the images are being paged back and forth with the server based on where the images are positioned in the image study.

In certain examples, an open study request is received from a patient information viewer (PIV), electronic medical record (EMR) web client, etc. A display pipeline reads through pixel data for image(s) in the study and applies DICOM attributes to pixel data for display. The modified pixel data is arranged for display using a canvas element, pixel shader, etc.

Via an “intelligent” ZFP Web browser-based viewer, compatibility can be determined First, compatibility is detected on the client side (e.g., fast and accurate on the client), then compatibility detection results are sent to the server. When the server generates a requested image and/or other information for the client, the server can generate the requested result without extra code that the client will not use. In addition to compatibility rendering, logging, auditing, and resource management are provided via the ZFP viewer.

In certain examples, a run-time multi-level cache (e.g., memory, disk, and source) provides support for a PACS and associated viewer. A ZFP middle tier serves as a proxy for storage on a PACS and/or other data archive (e.g., an enterprise archive, etc.), for example.

A WebSocket connection, for example, serves as a primary connection to provide fast data transfer without encoding. In certain examples, Web services can facilitate data transfer for clients that do not support WebSockets. Rendering of images can be done on the server to be provided to the ZFP client, for example. In certain examples, a WebSockets-based DICOM image streaming protocol prioritizes images in order with compression to a thin-client browser and/or other ZFP HTML viewer on the client, rather than thick client to thick client streaming.

In certain examples, a data manager is provided on a server. The data manager on the server performs data compression and transcoding of data to be sent to a client viewer. In certain examples, the data manager includes a non-image object converter to convert non-DICOM object to usable format.

In certain examples, “memory sensitive” image browsing is facilitated by tracking an amount of resources used and paging requested image data off of the server to send to the browser. In addition to keeping track of an amount of memory used, a receiving client device is analyzed to determine whether the client device is capable of processing a given type of image, for example.

Additionally, form factor-based streaming technology provides, based on available client device characteristics including size (form factor), an initial image compressed at a first resolution for viewing while a full lossless medical diagnostic quality image is downloaded in the background. In certain examples, by accounting for a client device's form factor when streaming image data, images can be rendered on the server for delivery to and display on a device that are specific to the size and/or other characteristic of the device.

For example, if the client device is a handheld or mobile device (e.g., a smart phone, a tablet computer, etc.) and a mammography image (e.g., 8-10 megabytes in size) is selected for display, the user will not typically be able to view the image in a timely manner on the device. However, by facilitating communication between the client device and the server, the client can provide the server with a desired display port size, and the server can create a progressively compressed resolution image. The resulting image can be sent to the client to be displayed in a lowest resolution for the viewport size on the client. The remainder of the data for the image can be transmitted to the client in the background while the user is viewing the lower resolution image on the client device. Thus, a user flexibly receives an appropriate resolution for a type of client device being used to display the image.

In certain examples, scaled and vector graphics (e.g., SVG-based DICOM GSPS) allows tracking of a data plane using eXtensible Markup Language (XML). Vector graphic coordinates can be represented using XML, and GSPS can be displayed for one or more images. For example, a PACS viewer creates a DICOM GSPS object. A ZFP viewer implements SVG. By encapsulating GSPS in an SVG object, the GSPS can work directly with the image in a ZFP browser in XML. With SVG, annotation can be shown with an SVG parser available in the ZFP viewer. The annotation can be overlaid on the image, and the browser knows how to display the annotation with respect to the image.

In certain examples, a WebSockets transport layer can be used to facilitate programmable workstation functions. While classically a browser has not been able to interact directly with a client other than through activeX components and advanced security privileges, WebSockets allows an application to run on the client that a browser can interact with directly using TCP sockets, for example. For example, multiple monitor support on the client can be facilitated via the browser without instantiating an activeX component. Using WebSockets, a browser can check on and interact with a client device directly. WebSocket connections can facilitate easier and more direct interoperability with third party applications, for example.

In certain examples, a remoting capability can be provided via a ZFP viewer. For example, JavaScript remoting function translation can be facilitated over WebSockets. A proxy can be created on the client side, and the proxy calls the server without translation, for example.

### X. Conclusion

Thus, certain examples provide client monitoring, transparent, remote execution at a server for benefit of the client, image streaming, etc. Certain examples facilitate such remote capability via a zero footprint platform and viewer that facilitates display, manipulation, reformatting, etc., of medical images (e.g., DICOM medical images) without a requirement for client installation, download of viewer component(s) at the client, etc., and which can run on virtually any hardware that is able to support an appropriate browser (e.g., an HTML5 browser). Certain examples provide a viewer component to facilitate image rendering and manipulation; a middle-tier server to support transcoding of data (e.g., DICOM data) for image pixels, metadata, and non-image objects. Using this novel architecture, efficient web based browsing of DICOM image studies can be accomplished without the addition of any extra components at the client system, for example.

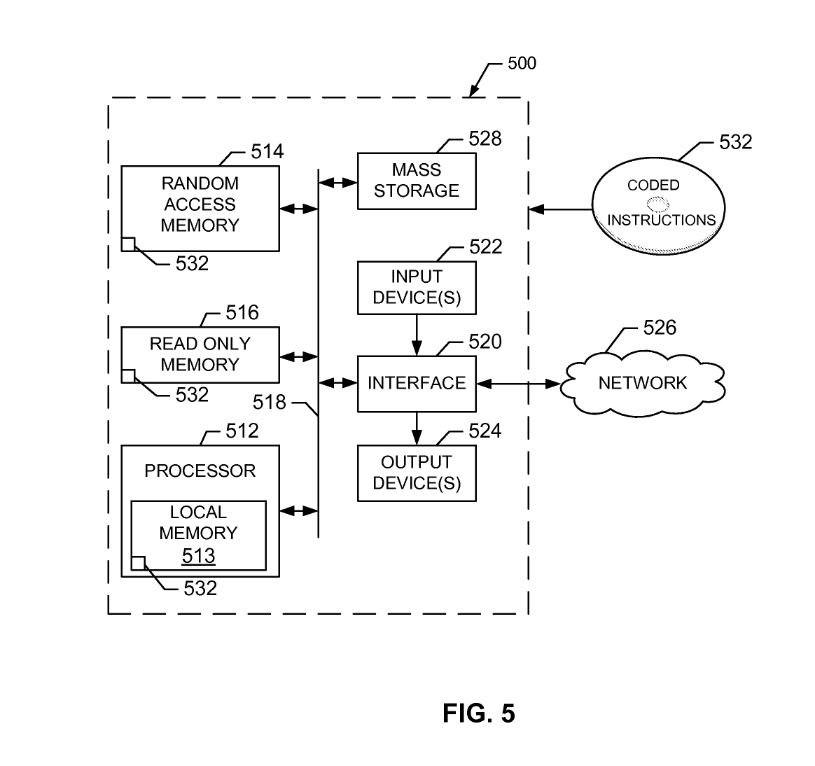

FIG. 5 is a block diagram of an example processor system 510 that may be used to implement systems and methods described herein. As shown in FIG. 5, the processor system 510 includes a processor 512 that is coupled to an interconnection bus 514. The processor 512 may be any suitable processor, processing unit, or microprocessor, for example. Although not shown in FIG. 5, the system 510 may be a multi-processor system and, thus, may include one or more additional processors that are identical or similar to the processor 512 and that are communicatively coupled to the interconnection bus 514.

The processor 512 of FIG. 5 is coupled to a chipset 518, which includes a memory controller 520 and an input/output (“I/O”) controller 522. As is well known, a chipset typically provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (“I/O”) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (“ATM”) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method comprising:
monitoring execution at a client device;
establish a communication channel with a client device and exchanging messages via the channel;
routing execution from the client device to a server and facilitating execution of the functionality at the server;
routing a result of the execution back to the client device; and
facilitating output of the results for access via the client device.

2. The method of claim 1, wherein the communication channel and routing are facilitated using WebSockets.

3. The method of claim 1, wherein the execution of functionality comprises viewing and selection of an image from an image series, wherein the server is to render and transmit the selected image to the client device via the communication channel without translation, the image to be displayed via the client device.

4. The method of claim 3, further comprising obtaining at least one of meta information and associated image information for the requested medical image and using the information to facilitate streaming of the image to the client device.

5. The method of claim 3, further comprising delivering, in response to a request, non-image information via the communication channel to the client device.

6. The method of claim 1, further comprising facilitating selection of the medical image from an image study based on a DICOM server-object pair instance unique identifier.

7. The method of claim 1, wherein monitoring is facilitating using a monitoring application running in the background of the client device.

8. The method of claim 1, wherein the monitoring application is to open the communication channel in a predefined WebSocket port.

9. The method of claim 1, further comprising executing an initial script on the client device based on monitored execution identifying a launch of an application at the client device, and then routing the execution to the server for remote execution of the application functionality.

10. The method of claim 9, further comprising translating remoting functionality to allow methods execution on the client device to be routed to the server via an encapsulated WebSocket connection for further execution and return to the client.

11. A tangible computer-readable storage medium including computer program code to be executed by a processor, the computer program code, when executed, to implement a method comprising:
monitoring execution at a client device;
establish a communication channel with a client device and exchanging messages via the channel;
routing execution from the client device to a server and facilitating execution of the functionality at the server;
routing a result of the execution back to the client device; and
facilitating output of the results for access via the client device.

12. The computer-readable storage medium of claim 11, wherein the communication channel and routing are facilitated using WebSockets.

13. The computer-readable storage medium of claim 11, wherein the execution of functionality comprises viewing and selection of an image from an image series, wherein the server is to render and transmit the selected image to the client device via the communication channel without translation, the image to be displayed via the client device.

14. The computer-readable storage medium of claim 13, wherein the method further comprises obtaining at least one of meta information and associated image information for the requested medical image and using the information to facilitate streaming of the image to the client device.

15. The computer-readable storage medium of claim 13, wherein the method further comprises delivering, in response to a request, non-image information via the communication channel to the client device.

16. The computer-readable storage medium of claim 11, wherein the method further comprises facilitating selection of the medical image from an image study based on a DICOM server-object pair instance unique identifier.

17. The computer-readable storage medium of claim 11, wherein monitoring is facilitating using a monitoring application running in the background of the client device.

18. The computer-readable storage medium of claim 11, wherein the monitoring application is to open the communication channel in a predefined WebSocket port.

19. The computer-readable storage medium of claim 11, wherein the method further comprises executing an initial script on the client device based on monitored execution identifying a launch of an application at the client device, and then routing the execution to the server for remote execution of the application functionality.

20. The computer-readable storage medium of claim 19, wherein the method further comprises translating remoting functionality to allow methods execution on the client device to be routed to the server via an encapsulated WebSocket connection for further execution and return to the client.
